(19) United States
(12) Patent Application Publication
(10) Pub. No.: US 2016/0049855 A1
(43) Pub. Date: Feb. 18, 2016

(54) MAGNETIC CYCLOID GEAR

(71) Applicant: NATIONAL OILWELL VARCO, L.P., Houston, TX (US)

(72) Inventor: Kent R. Davey, Edgewater, FL (US)

(73) Assignee: NATIONAL OILWELL VARCO, L.P., Houston, TX (US)

(21) Appl. No.: 14/774,829

(22) PCT Filed: Mar. 6, 2014
(86) PCT No.: PCT/US14/21168

§ 371 Date: Sep. 11, 2015

Related U.S. Application Data
(60) Provisional application No. 61/783,636, filed on Mar. 14, 2013.

(51) Int. Cl. H02K 49/10; E21B 19/02; E21B 21/01; E21B 3/02

(52) U.S. Cl. CPC H02K 49/106; E21B 3/02; E21B 19/02; E21B 21/01; H02K 49/102

(57) ABSTRACT

A magnetic cycloid gear includes an outer gear member comprising a first plurality of magnets that provide a first number of magnetic pole pairs, wherein the outer gear member has an outer gear member axis, and an inner gear member comprising a second plurality of magnets that provide a second number of magnetic pole pairs, wherein the inner gear member has an axis that is offset from the outer gear member axis and wherein the second number of magnets differs from the first number of magnets. The gear further includes a drive mechanism operatively coupled to rotate the inner gear member as it revolves in an eccentric manner relative to the outer gear member axis, and a constraint mechanism coupled to the inner gear member to prevent it from rotating bout its own axis as it revolves. The outer gear member rotates in response to the inner gear member revolving.

### CROSS-REFERENCE TO RELATED APPLICATIONS

This application claims priority to U.S. Provisional Patent Application No. 61/783,636, filed Mar. 14, 2013 and entitled “Magnetic Cycloid Gears, and Related Systems and Methods,” which is incorporated by reference herein in its entirety.

### TECHNICAL FIELD

The present disclosure relates generally to radial cycloid magnetic gears, and related systems and methods, including for example, for use in various rotary driven industrial equipment, such as, for example, top drives, drawworks, and/or mud pumps of oil rigs.

### INTRODUCTION

The section headings used herein are for organizational purposes only and are not to be construed as limiting the subject matter described in any way.

Gearboxes and gear arrangements are utilized in a wide range of applications in order to provide speed and torque conversions from a rotating power source to another device. Traditionally, gearboxes have been formed from gear rings, or wheels, each being sized and having a number of teeth selected to provide a desired gear ratio, which in turn affects the torque ratio. Such mechanical gearboxes, however, may produce relatively large acoustic noise and vibration. Also, the mechanical components of gearboxes are subject to wear and fatigue (e.g., tooth failure), and require periodic lubrication and maintenance. Moreover, mechanical gear arrangements can have inefficiencies as a result of contact friction losses.

Magnetic gear arrangements have been developed as a substitute for mechanical gear arrangements. Some magnetic gears are planetary in their arrangement and comprise respective concentric gear rings with interpoles positioned between the gear rings. The rings incorporate permanent magnets, and the interpoles act to modulate (shutter) the magnetic flux transferred between the permanent magnets of the gear rings. In this manner, there is no mechanical contact between the gear rings, or the input and output shafts of the gearbox. Thus, utilizing such magnetic gear arrangements may alleviate many of the noise and wear issues associated with gears that rely on intermeshing teeth.

Other magnetic gear arrangements are analogous to mechanical cycloid gears. Some such gears include harmonic gears that utilize a flexible, thin-walled toothed spline structure that moves within and intermeshes with a fixed outer toothed spline; this structure sometimes being referred to as a skin. A wave generator may be attached to an input shaft and rotated within the flexible spline to rotate the flexible spline around and within the outer fixed spline, with the flexible inner spline being attached to an output shaft. Mechanical harmonic gears generally are characterized by relatively high gear ratios and minimal backlash, which is the error in motion that occurs based on the size of the gap between the leading face of the tooth on the driven gear and the trailing face on the tooth of the driving gear. The flexible spline structures of mechanical harmonic gears are a relatively weak structural component that limits the output torque of such gears, thus providing relatively low output torques.

In at least one analogous magnetic cycloid gear arrangement, an inner rotor gear ring supports an array of magnets and an outer stator gear ring supports an array of magnets. The number of magnets on the inner and outer gear rings differ, and the inner rotor gear ring axis is offset from the outer stator gear ring axis, with the inner rotor gear ring being allowed to also freely rotate about its own axis as it is driven by a drive shaft aligned with the outer stator gear ring axis. The nearest magnets between the inner and outer gear rings have the strongest attraction. When the shaft creating the eccentric rotation or wobble makes a full rotation, the inner rotor gear ring has not returned to its original position because of the different number of magnets. That slight rotation shift can be used to create a large torque.

Although existing magnetic gears, whether planetary or cycloidal, alleviate some of the drawbacks associated with mechanical gears, and can offer relatively high gear ratios, there exists a continued need for improvement in magnetic gear arrangements. For example, there exists a continued need to improve upon the torque density in magnetic gears. Moreover, there exists a continued need to provide magnetic gear arrangements with a smaller part count. There also exists a need in various industrial applications to drive rotary equipment with torque conversion systems, such as gears, that are able to withstand potentially harsh environments that may damage conventional mechanical gears and/or require relatively high maintenance; for example, in the oil and gas drilling industry, there exists a need to improve upon the motors and gearing equipment used to drive rotary equipment.

### SUMMARY

The present disclosure may solve one or more of the above-mentioned problems and/or achieve one or more of the above-mentioned desirable features. Other features and/or advantages may become apparent from the description which follows.

In accordance with at least one exemplary embodiment, the present disclosure contemplates a magnetic cycloid gear that includes an outer gear member comprising a first plurality of magnets that provide a first number of magnetic pole pairs; wherein the outer gear member has an outer gear member axis, an inner gear member comprising a second plurality of magnets that provide a second number of magnetic pole pairs, wherein the inner gear member has an inner gear member axis that is offset from the outer gear member axis and wherein the second number of magnetic pole pairs differs from the first number of magnetic pole pairs. The magnetic cycloid gear may further include a drive mechanism operatively coupled to the inner gear member to impart a rotary motion to the inner gear member to revolve the inner gear member in an eccentric manner relative to the outer gear member axis, and a constraint mechanism coupled to the inner gear member to prevent the inner gear member from rotating about an axis of the inner gear member as it revolves. The outer gear member can move in a rotary manner in response to the inner gear member revolving.

In another exemplary embodiment, the present disclosure contemplates a system that includes a magnetic cycloid gear, for example, arranged as above, a high speed, low torque input shaft operatively coupled to the inner gear member of the magnetic gear, and a low speed, high torque output shaft operatively coupled to the outer gear member of the magnetic gear. The system may further include rotary equipment associated with an oil drilling rig operatively coupled to be driven by the output shaft.

In yet another exemplary embodiment, the present disclosure contemplates A method of torque conversion that includes imparting a rotary drive motion to an inner gear member comprising a first plurality of magnets providing a first number of pole pairs, wherein the rotary drive motion is from a high speed, low torque input. The method can further include constraining the rotary motion of the inner gear member from rotating about an axis of the first gear member as the inner gear member revolves in an eccentric manner within an outer gear member, wherein the outer gear member comprises a second plurality of magnets providing a second number of pole pairs that differs from the first number of pole pairs. In response to the movement of the inner gear member, the method may include permitting the outer gear member to move in a rotary manner to provide a low speed, high torque output.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

It is to be understood that both the foregoing general description and the following detailed description are exemplary and explanatory only and are not restrictive of the invention, as claimed. It should be understood that the invention, in its broadest sense, could be practiced without having one or more features of these exemplary aspects and embodiments.

### BRIEF DESCRIPTION OF DRAWINGS

The accompanying drawings, which are incorporated in and constitute a part of this specification, illustrate some exemplary embodiments of the present disclosure and together with the description, serve to explain certain principles. In the drawings,

FIG. 1 is a schematic plan view of magnetic cycloid gear rings in accordance with the present disclosure;

FIGS. 2A and 2B are schematic perspective and plan views, respectively, of an exemplary embodiment of a magnetic cycloid gear illustrating principles of operation in accordance with the present disclosure;

FIGS. 3A-3D are schematic perspective views illustrating exemplary positions of the magnetic cycloid gear rings of FIGS. 2A and 2B during exemplary operation of the gear;

FIGS. 4A and 4B are schematic plan and partial detailed views, respectively, of another exemplary magnetic cycloid gear arrangement;

FIGS. 5A and 5B show schematic top perspective and bottom perspective views, respectively, of a magnetic cycloid gear arrangement in accordance with an exemplary embodiment;

FIG. 6 is a graph showing how maximum torque varies with the differential radius for a magnetic cycloid gear arrangement in accordance with various exemplary embodiments;

FIGS. 7A-7D depict plan schematic views of magnetic cycloid inner and outer gear ring relative positions to illustrate principles relating to various exemplary embodiments of the present disclosure;

FIG. 8 is a schematic, partial plan view of inner and outer gear rings of a magnetic cycloid gear arrangement according to an exemplary embodiment;

FIG. 9A is a perspective view of an exemplary embodiment of a magnetic cycloid gear arrangement;

FIG. 9B is a perspective, cross-sectional view along line 9B-9B in FIG. 9A;

FIG. 10 is a schematic cross-sectional view of an exemplary embodiment of a magnetic cycloid gear and motor drive assembly for use to drive a top drive in accordance with the present disclosure;

FIG. 11 is a perspective view of an exemplary embodiment of an eccentric ring with bearing;

FIG. 12 is a schematic cross-sectional view of another exemplary embodiment of a magnetic cycloid gear and motor drive assembly for use to drive a top drive in accordance with the present disclosure;

FIG. 13 is a schematic cross-sectional view of another exemplary embodiment of a magnetic cycloid gear and motor drive assembly for use to drive a top drive in accordance with the present disclosure;

FIGS. 14A and 14B are schematic plan and partial detailed views depicting magnetic flux and force vectors created by inner and outer gear rings of a magnetic cycloid gear arrangement according to an exemplary embodiment;

FIG. 15A is a perspective view of an exemplary embodiment of a magnetic cycloid gear arrangement for use with a top drive in accordance with the present disclosure;

FIG. 15B is an end view of the magnetic cycloid gear arrangement of FIG. 15A;

FIG. 15C is a perspective cross-sectional view along line 15C-15C in FIG. 15A;

FIG. 15D is an exploded perspective view of the magnetic cycloid gear arrangement of FIG. 15A;

FIG. 16 is a schematic view of an exemplary oil drilling rig system with which magnetic cycloid gear arrangements in accordance with various exemplary embodiments may be used to drive rotary equipment of the system;

FIG. 17 is a diagrammatic perspective view of a top drive with integrated magnetic cycloid gear and motor drive assembly in accordance with various exemplary embodiments.

### DESCRIPTION OF EXEMPLARY EMBODIMENTS

Reference will now be made in detail to various exemplary embodiments of the present disclosure, examples of which are illustrated in the accompanying drawings. Wherever possible, the same reference numbers will be used throughout the drawings to refer to the same or like parts.

In accordance with various exemplary embodiments, magnetic cycloid gear arrangements can provide improved performance (e.g., gear ratios and output torque densities) with less magnet volume than various other magnetic gear configurations. For example, various exemplary embodiments of magnetic cycloid gears described herein may have gear ratios that are on the order of or greater than 30:1, for example about 31:1. In various exemplary embodiments, the magnetic cycloid gears can be sized to achieve a torque output sufficient for driving rotary equipment, such as a top drive, in an oil drilling rig. For example, the torque output may range from about 25,000 ft-lbs to about 29,000 ft-lbs. In an exemplary embodiment, a magnetic cycloid gear arrangement that achieves such torque outputs may be about 15″ in length and about 24″ in diameter. Accordingly, the torque input required to drive the gear rotor only has to deliver 1/30^{th} of the torque, and thus may be relatively small. As a consequence, the gear arrangements in accordance with various exemplary embodiments may utilize relatively small motors that can be placed in relatively small spaces associated with the gear, such as, for example, inside the gear rotor. This may permit providing gear arrangements that are relatively compact.

In various exemplary embodiments, magnetic cycloid gear arrangements in accordance with the present disclosure may be useful to deliver torque to drive a variety of rotary equipment, including but not limited to, for example rotary equipment in oil drilling systems. The use of such magnetic cycloid gear arrangements in accordance with the present disclosure in oil drilling systems and other applications may be desirable as the arrangements can be relatively compact designs, with relatively few components that deliver high torque in an integrated motor/gear system. Moreover, the use of magnetic gearing can reduce vibrations, acoustic issues, and wear that are associated with conventional mechanical (e.g., toothed) gear systems. Also, by reducing the number of contacting mechanical parts, friction losses and potential damage due to harsh environments, as are sometimes associated with oil drilling rigs and other industrial applications, can be mitigated using magnetic gearing arrangements.

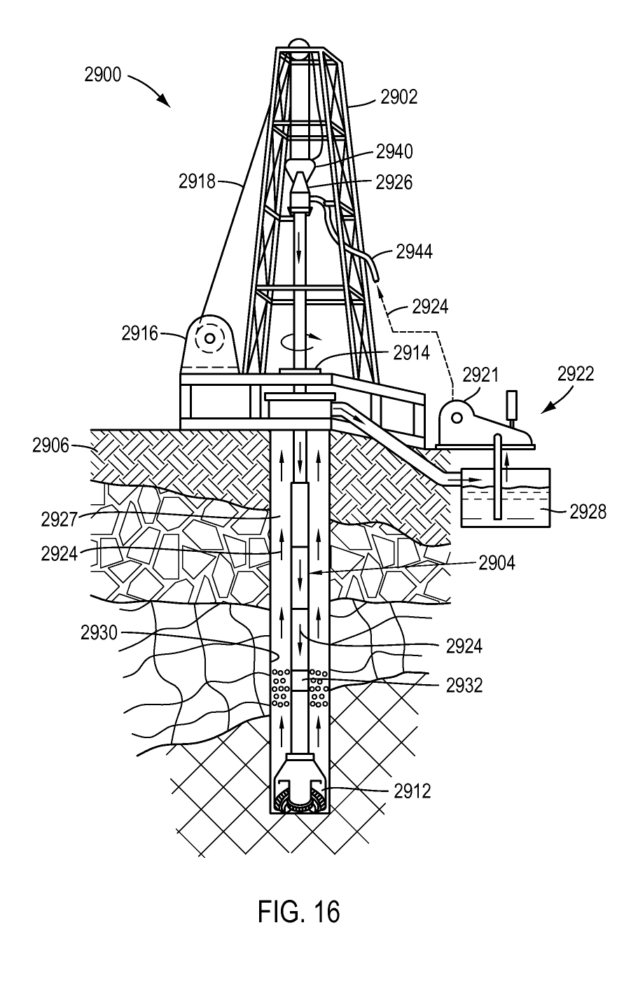

Reference is made to FIG. 16, which illustrates a schematic diagram depicting an oil drilling rig 2900 for which the magnetic cycloid gear arrangements in accordance with various exemplary embodiments may be used in accordance with aspects of the present disclosure. The rig 2900 includes a derrick 2902 from which extends a drill string 2904 into the earth 2906. The drill string 2904 can include drill pipes and drill collars. A drill bit 2912 is at the end of the drill string 2904. A rotary system 2914, top drive 2926, and/or a downhole drive 2932 (e.g., a “fluid motor”, “mud motor”, electric, hydraulic, mud, fluid, or other type based on available utilities or other operational considerations) may be used to rotate the drill string 2904 and the drill bit 2912. The top drive 2926 is supported under a travelling block 2940, which can travel up and down in the derrick 2902. A drawworks 2916 has a cable or rope apparatus 2918 for supporting items in the derrick 2902 including the top drive 2926. A system 2922 with one, two, or more mud pump systems 2921 supplies drilling fluid 2924 using hose 2944 to the drill string 2904, which passes through the center of the top drive 2926. Drilling forms a wellbore 2930 extending down into the earth 2906.

During drilling, the drilling fluid 2924 is pumped by mud pump(s) 2921 of the system 2922 into the drill string 2904 passing through the top drive 2926 (thereby operating a downhole drive 2932 if such is used). Drilling fluid 2924 flows to the drill bit 2912, and then flows into the wellbore 2930 through passages in the drill bit 2912. Circulation of the drilling fluid 2924 transports earth and/or rock cuttings, debris, etc. from the bottom of the wellbore 2930 to the surface through an annulus 2927 between a well wall of the wellbore 2930 and the drill string 2904. The cuttings are removed from the drilling fluid 2924 so that the fluid may be re-circulated from a mud pit or container 2928 by the pump(s) of the system 2922 back to the drill string 2904. In operation, the rotary equipment, such as top drive 2926, drawworks 2916, mud pumps 2921, may be driven by motors and one or more magnetic cycloid gear arrangements in accordance with exemplary embodiments herein, which can provide large torque at low speed.

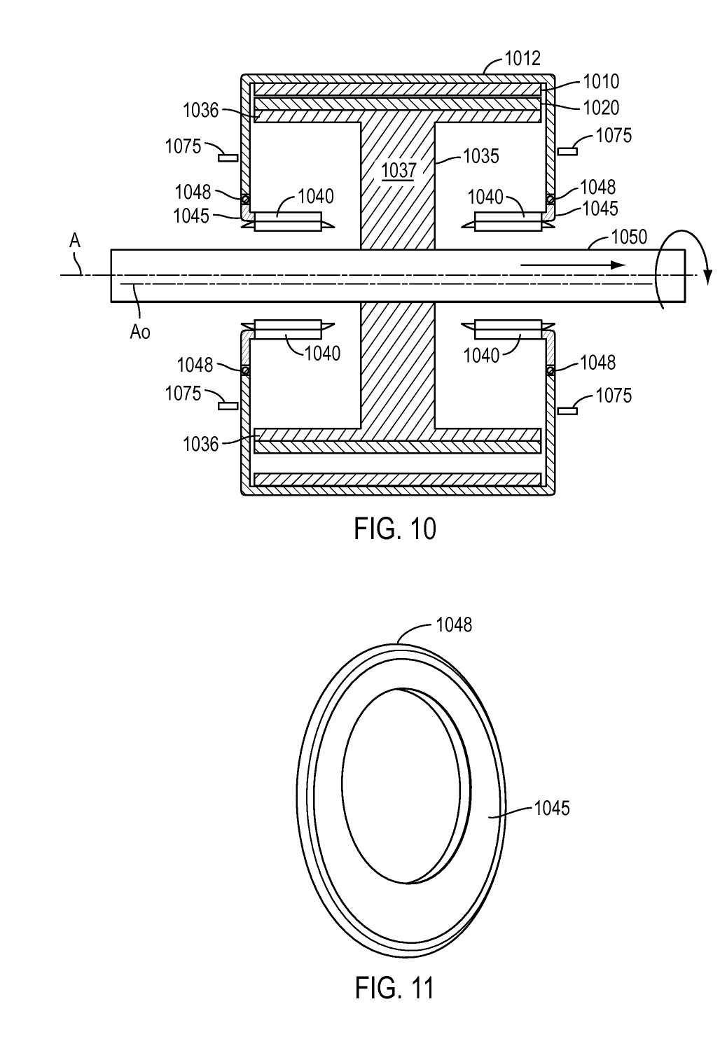

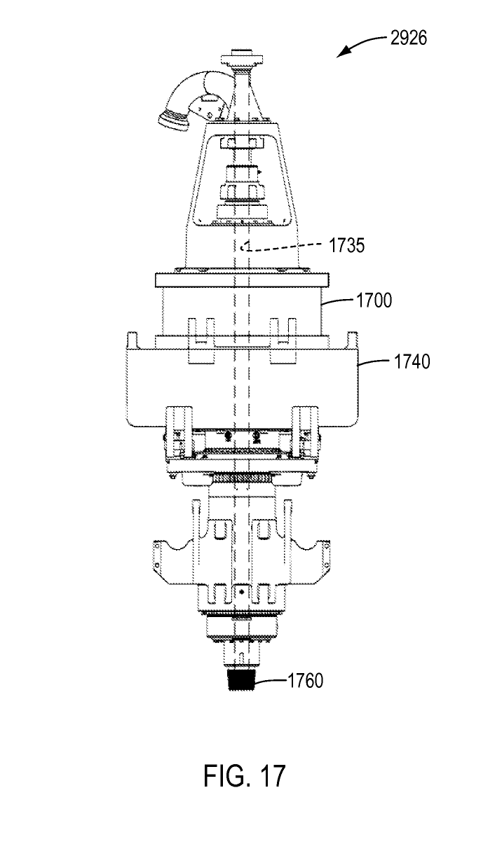

FIG. 17 illustrates one exemplary embodiment of a top drive 2926 with an integrated magnetic cycloid gear and motor drive assembly 1700 in accordance with various exemplary embodiments, as will be described further below (see, e.g., FIGS. 10, 12, 13, and 15A-15D). Other parts of the top drive include a swivel house 1740 and main shaft 1760. The magnetic cycloid gear and drive assembly 1700 may have a passage 1735 there through (e.g., like mud pipes described in further detail below). The output of the drive may be of high torque and slow speed in an industrial scale, or varied torque/speed characteristics.

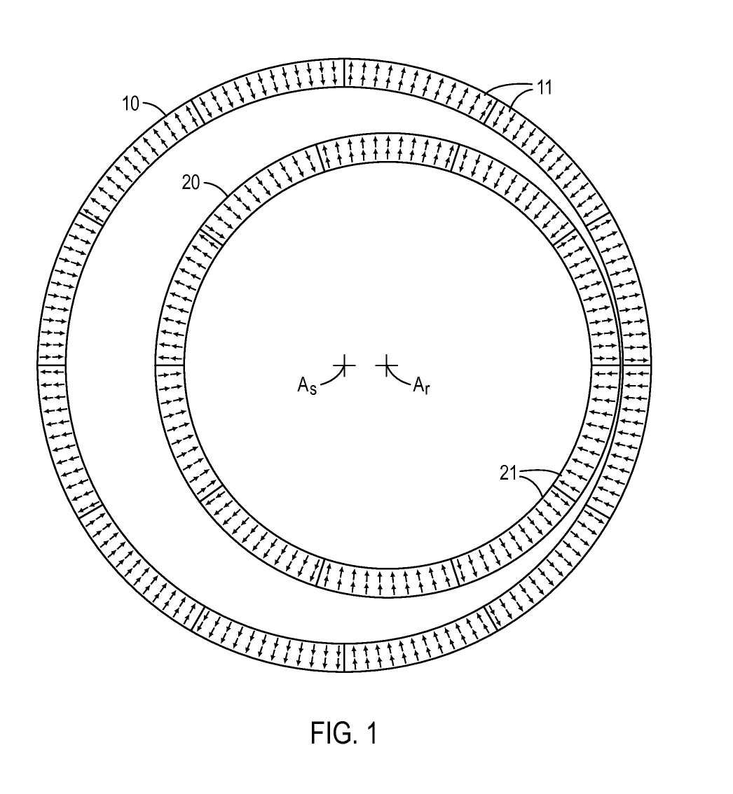

Referring now to FIG. 1, a schematic plan view of gear rings of a magnetic cycloid gear is depicted. The gear rings include an outer gear ring 10 and an inner gear ring 20. The outer gear ring 10 carries a plurality of magnets 11 around the ring 10, and the inner gear ring 20 carries a plurality of magnets 21 around the ring 20, with the number of magnets on the inner gear ring 20 being less than the number on the outer gear ring 10. In various exemplary embodiments of magnet cycloid gear arrangements described herein, as would be understood by those of ordinary skill in the art, the gear rings carry permanent magnets and use of the term magnets herein encompasses such permanent magnets. In the example of FIG. 1, the outer gear ring 10 carries twelve magnets 11 and the inner gear ring 20 carries ten magnets 21. As also shown in FIG. 1, in a magnetic cycloid gear arrangement, the rotor axis Aᵣ is displaced (e.g., to the right in the view and position of the gear rings in FIG. 1). In other words, the inner and outer gear rings are positioned in a non-concentric manner such that their axes are not aligned. If either the inner gear ring or the outer gear ring is allowed to move as a whole such that its axis traces a small orbital path (e.g., revolves), the magnets of the inner and outer gear rings will be in closest proximity at various angular positions during the revolving. By way of example, if the inner ring is allowed to also rotate about its axis Aᵣ during this, while it revolves and with the outer gear ring held stationary, the resulting gear ratio is 5:−1. In another example, if the inner gear ring is held stationary and the outer gear ring is allowed to revolve as describe above, as well as rotate about its own axis, the resulting gear ratio is 6:1.

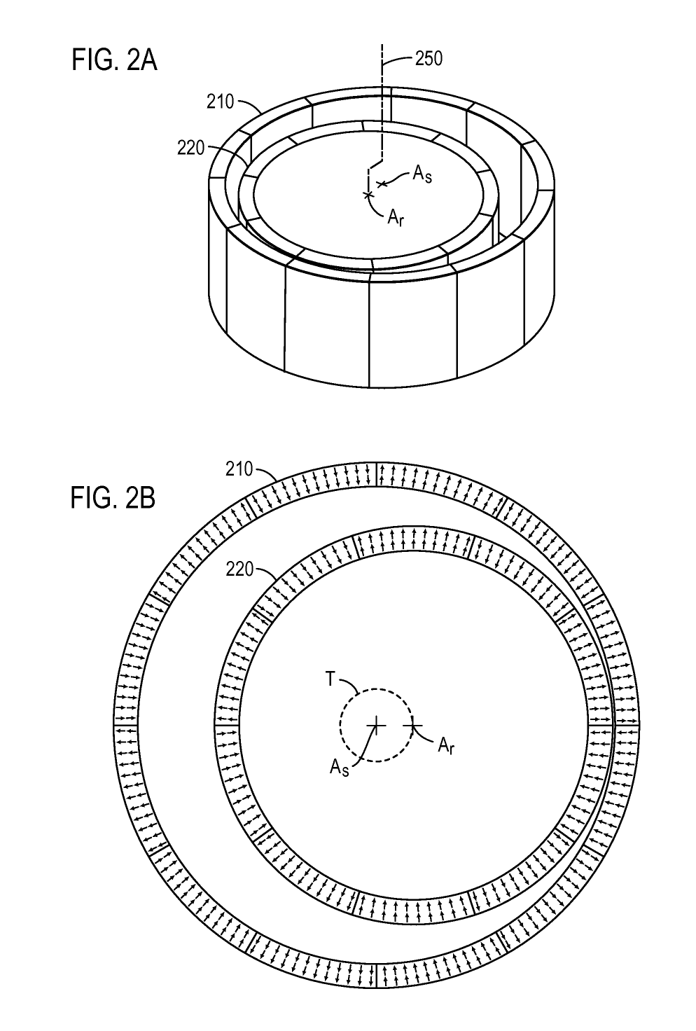

Referring now to FIGS. 2A-4, principles of operation of conventional magnetic cycloid gears will now be described. In a conventional cycloid gear arrangement, the inner gear ring 220 may be driven by an eccentric input drive shaft 250 that is aligned with the outer gear ring axis Aₛ at its input rotation axis and is fixed at its other end to the inner gear ring axis Aᵣ. When this input drive shaft 250 is rotated (i.e., about the axis Aₛ), the end of the input shaft 250 fixed at the axis Aᵣ, and thus the position of Aᵣ, traces out the trajectory T shown in the dashed lines of FIG. 2B.

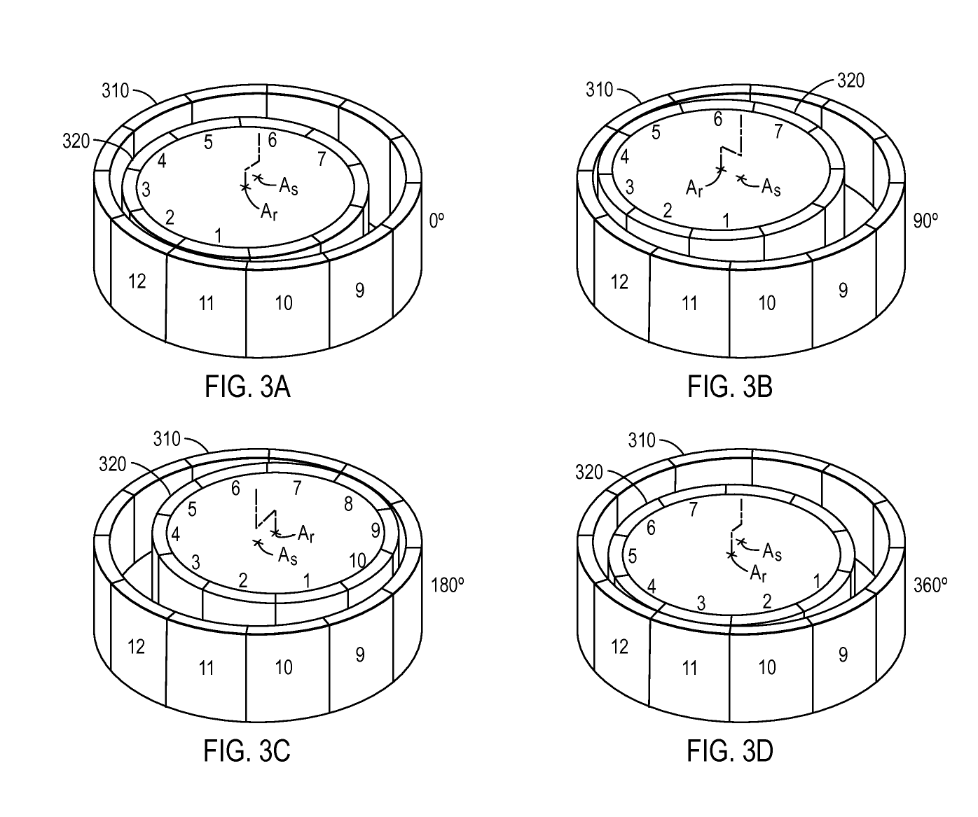

FIGS. 3A-3D illustrate schematically how a gear arrangement of FIGS. 2A-2B works with the inner gear ring 320 provided with ten magnets and the outer gear ring 310 provided with twelve magnets. With the inner gear ring 320 freely spinning about its own axis Aᵣ as it is driven by an eccentric input drive shaft that rotates around axis A_{S}, as described above with reference to FIGS. 2A and 2B, in the starting position at 0 degrees of FIG. 3A, magnets 1 and 2 of the inner gear ring 320 are closest to the outer gear ring 310 and, as depicted, magnet 1 is substantially radially aligned with the magnet labeled 11 of the outer gear ring 310, and the magnet labeled 2 on the inner gear ring 320 is substantially radially aligned with the magnet labeled 12 on the outer gear ring 310. As the input shaft continues its rotation in a clockwise position 90 degrees, as illustrated in FIG. 3B, the inner gear ring 320 rotates about axis Aᵣ in a counterclockwise manner such that magnet 1 on the inner gear ring 320 has rotated counterclockwise slightly and a distance away from the outer gear ring 310 and the magnet labeled 11, while the magnets labeled 4 and 5 on inner gear ring 320 assume the closest position to the outer gear ring 310. Because there are fewer magnets on the inner gear ring 320 than the outer gear ring 310, the result is a counterclockwise rotation of the inner gear ring 320. The inner gear ring magnets that are closest to the outer gear ring 310 inhibit slippage from their nearest inner gear ring magnet. At the 180 degree position of rotation of the inner gear ring 320, as depicted in FIG. 3C, the magnets labeled 7 and 8 assume the closest position to the outer gear ring 310. And after 360 degrees of rotation as depicted in FIG. 3D, the inner gear ring 320 has rotated in a counterclockwise direction about its axis Aᵣ by about two magnet positions, e.g., such that the magnet labeled 1 is substantially aligned with the magnet labeled 9 on the outer gear ring 310. This results in a counterclockwise rotation of 2/10*360 degrees of the inner gear ring 320 for every 360 degrees clockwise rotation of the input shaft. For the gear arrangement depicted in FIGS. 3A-3D, five clockwise revolutions of the input shaft about the axis Aₛ result in one counterclockwise rotation of the inner gear ring 320, thereby resulting in a −10/2 or a five to one (5:−1) gear ratio.

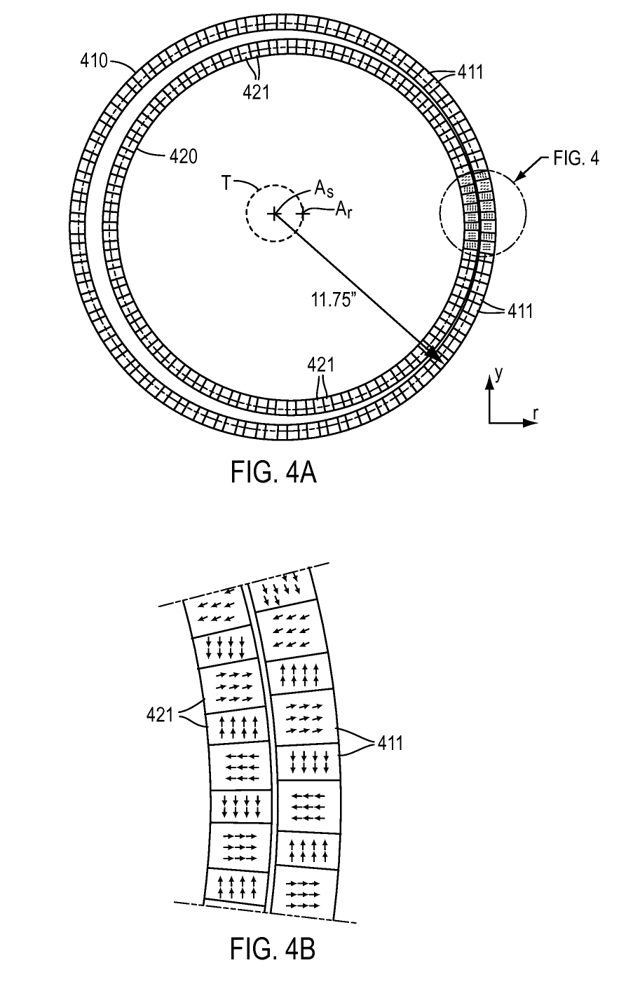

The gear operation (i.e., conversion of an input torque/speed torque/speed to an output torque/speed) of a magnetic cycloid gear occurs when the number of magnets on the input and output gear rings differ, with the largest breakout torque being realized when the pole pair difference is one. In other words, the largest torque occurs when the output gear ring slips about ½ of a magnetic pole pitch back from its closest fixed magnet mate. FIGS. 4A and 4B show a schematic plan and partial detailed view of another exemplary magnetic cycloid gear arrangement that includes inner and outer gear rings 420, 410 carrying magnets 421, 411 arranged in a partial Halbach arrangement with 30 pole pairs (60 magnetic poles) on the inner gear ring 420 and 31 pole pairs (62 magnetic poles) on the outer gear ring 410. Because they are arranged in a Halbach array with tangential magnets, the number of magnets for the inner and outer rings 420, 410 is 120 and 124, respectively. In FIGS. 4A and 4B, two blocks represent one magnet pole and four blocks represents one magnet pole pair. In one exemplary embodiment, the radius of the inner gear ring 420 may be ⅝″ smaller than the outer gear ring 410 and its center displaced 0.5 in. horizontally (to the right in the position and orientation of FIG. 4). As above, when the inner gear ring 420 is coupled to an input shaft to rotate such that its axis Aᵣ traces the dashed line T, the inner gear ring 420 also can undergo a relatively slow rotation in the same direction about its own axis Aᵣ equal to a rotation of −2/60*360° for one complete rotation of the axis Aᵣ of the inner gear ring 420 about the trajectory T. Therefore, this would be a −60/2 or a 30:−1 gear ratio. As above, this rotation about Aᵣ results from the coupling between the magnets 421 and 411 in light of the differential pole pairs between the two rings 420, 410.

To achieve higher gear ratios, various exemplary embodiments of the present disclosure contemplate prohibiting the free rotation of one of the gear rings of a magnetic cycloid gear arrangement around its own axis, such as for example prohibiting the free rotation of the inner gear ring around its axis Aᵣ in FIGS. 2-4, while permitting it to revolve such that its axis traces out a small inner orbital trajectory (e.g., T in FIGS. 2-4). In addition, various exemplary embodiments contemplate permitting the other of the gear rings to rotate freely about its own axis in response to the magnetic coupling caused by the motion of the inner gear ring. For example, the outer gear ring in various exemplary embodiments may be permitted to rotate freely around its axis A_{S} in FIGS. 2-4, in response to movement of the inner gear ring. In the example arrangement above, the outer ring thus rotates in the same direction 2/62*360° for every complete revolution of the axis Aᵣ of the inner gear ring 420 about the trajectory T. Such a gear arrangement has a gear ratio of 61:2 or 30.5:1.

Further, as described in more detail below, various exemplary embodiments of magnetic cycloid gear arrangements provide a force balance that helps to stabilize the rotation of the gear rings. Moreover, various exemplary embodiments provide gear arrangements that can provide a relatively smooth take off of the torque transfer that is output from the gear arrangement, while using relatively few parts and a robust design.

As mentioned above and with reference again to FIG. 4A, in one exemplary operation, the inner gear ring 420 can move as a whole such that its axis Aᵣ revolves to trace a path along the dashed line T, while the inner gear ring 420 is prevented from rotating about its own axis Aᵣ. At the same time, the outer gear ring 410 may be free to rotate about its axis A_{S} in response to the movement of the inner gear ring 420 and by virtue of the magnetic coupling with the inner gear ring 420. In one full revolution of the inner gear ring's axis Aᵣ about the dashed line trajectory T, the outer gear ring 410 rotates 360/31° in the same direction as the inner gear ring 420. Without changing any of the other components described above, this gear arrangement results in a gear ratio of 31:1. For a fixed outer gear ring radius and working length, the maximum pullout torque as a function of magnet thickness increases, as does the force on the magnets tending to realign them as the inner gear ring is rotated relative to the outer gear ring. When steel is placed around the magnets, the restoring force tending to realign the magnets increases slightly. The restoring force is primarily in the tangential direction (the Y-direction shown in FIG. 4A) when the torque load is large, and is primarily in the radial direction when the torque load is small.

### Design Considerations for Magnetic Cycloid Gear Arrangements

### Dimensions of Gear Rings and Magnets

The radial dimensions and relative positions of the gear rings is a design consideration that can significantly impact the maximum pullout torque in various exemplary embodiments of magnetic cycloid gear arrangements described herein.

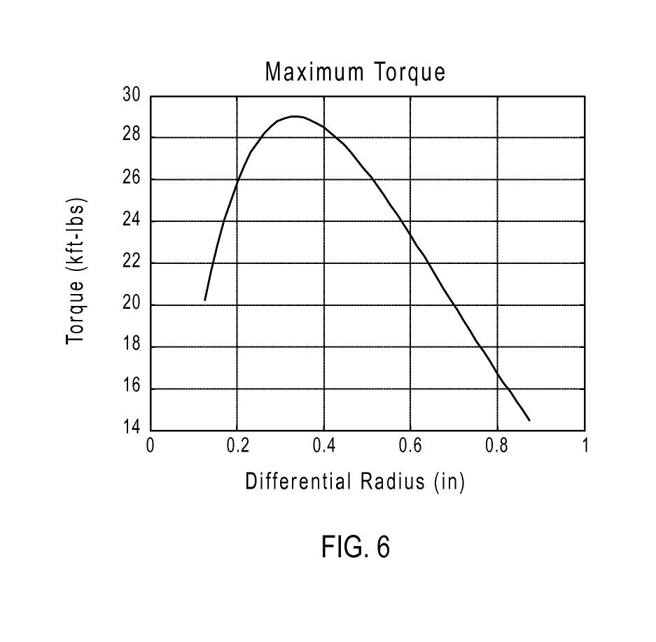

FIG. 6 shows how the maximum pullout torque changes as the differential radius between the inner and outer gear rings changes. The differential radius is the difference between the inner radius of the outer gear ring less the outer radius of the inner gear ring. The results shown in FIG. 6 were obtained by finite element modeling and displacing the inner gear ring axis horizontally from the outer gear ring axis by a distance equal to the differential radius less 0.125″.

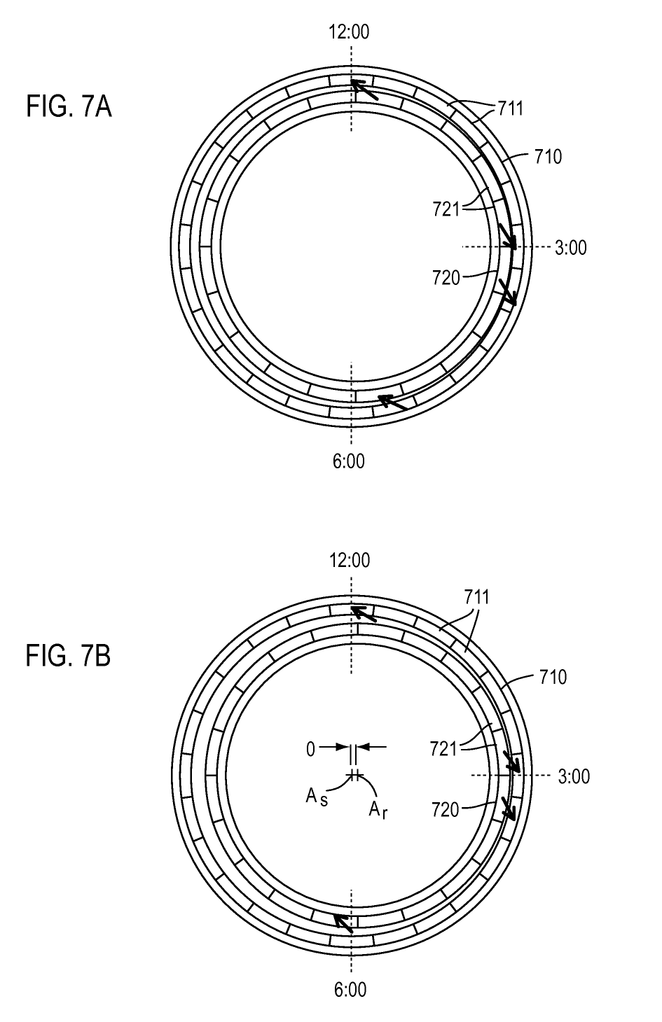

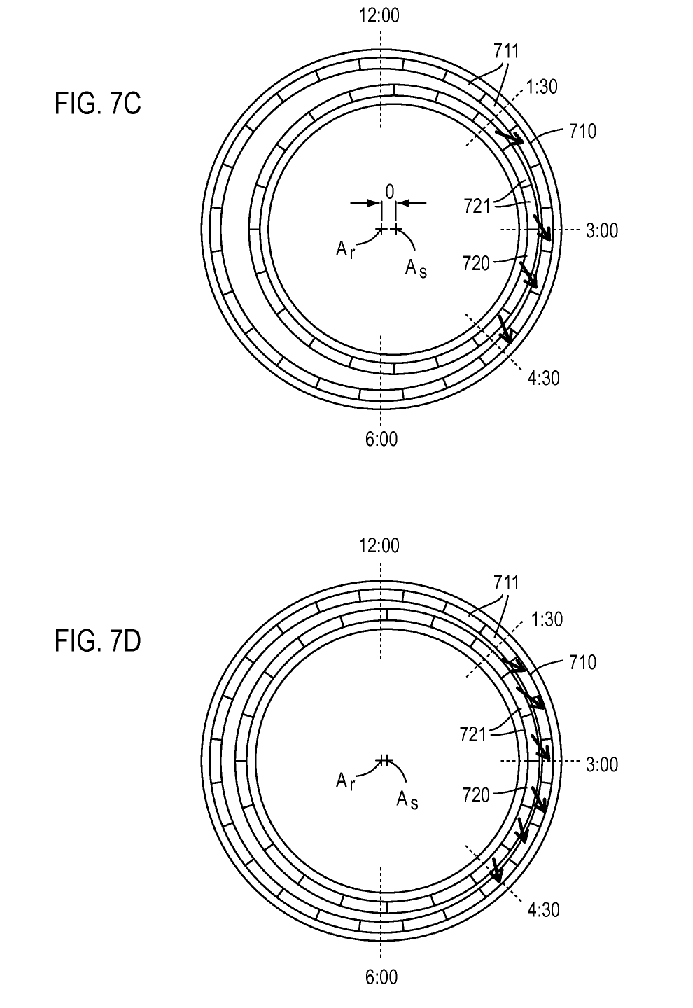

With reference to the schematic plan view of FIG. 7A, with the axes of the inner and outer gear rings 720, 710 offset, if the outer diameter of the inner gear ring 720 is too large relative to the inner diameter of the outer gear ring 710, the magnets 721 on the inner gear ring 720 at the 12:00 and 6:00 positions denoted tend to generate a flux and corresponding torque (shown by the arrows proximate those positions in FIG. 7A) that tends to cancel the primary torque generated by the magnet 711 and 721 at the 3:00 position, shown by the arrows proximate that position. The cancellation results from the inner gear ring 720 having one less pole pair than the outer gear ring 710. The increased gap created by an increased radial differential between the outer diameter of the inner gear ring 720 and the inner diameter of the outer gear ring 710, as well as the offset O of the inner gear ring axis Aᵣ relative to the outer gear ring axis A_{S}, as schematically depicted in FIG. 7B, can mitigate this cancellation effect (as above, the arrows at the 12:00, 3:00, and 6:00 position representing the torque generated from the resulting magnetic fluxes).

With reference now to FIGS. 7C and 7D, on the other hand, if the outer diameter of the inner gear ring 720 is too small relative to the inner diameter of the outer gear ring 710, the magnets 721 and 711 at the 1:30 and 4:30 positions are too far apart to provide any significant support for the maximum torque realized at the 3:00 position, as depicted by the arrows in FIG. 7C. In such an arrangement, the magnet gap becomes too great to provide substantial support for desired torque. In contrast, as depicted in FIG. 7D, with the appropriate radial differential (as in FIG. 7B above), the magnets 721 and 711 at the 1:30 and 4:30 positions provide good support for the primary torque generated at the 3:00 position, again as depicted by the arrows in FIG. 7D.

Based on the present disclosure, those having ordinary skill in the art would appreciate how to select the relative sizes of the inner and outer gear rings and the offset O of the inner gear ring and outer gear ring axes based on a variety of factors, including but not limited to, for example, the number of magnets on each of the gear rings, the size of the magnets, the desired gear ratio and output torque. In various exemplary embodiments, the radial differential may range from about 0.1 in. to about 0.6 in. Further, in various exemplary embodiments, the offset O may range from about 0.1 in. to about 0.6 in.

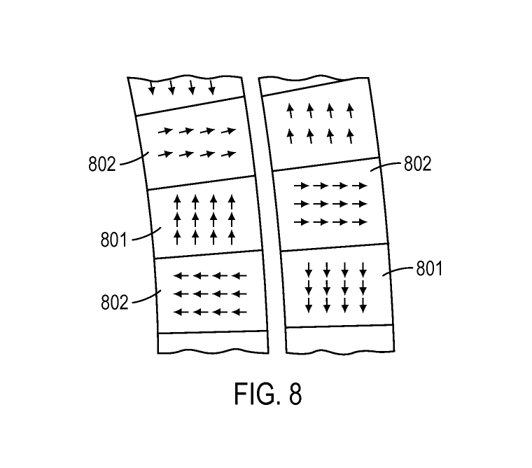

In comparison to the relative size and displacement of the inner and outer gear rings, adjusting the azimuthal span of the magnets may be a less sensitive parameter that affects the breakout torque of a magnetic cycloid gear arrangement in accordance with various exemplary embodiments. In an exemplary embodiment, as depicted in the partial plan view of the inner and outer gear rings in FIG. 8, the azimuthal span can differ for the magnets that are magnetized with a tangentially directed magnetic flux (magnets 801 in FIG. 8) and the magnets that are magnetized with a radially directed flux (magnets 802 in FIG. 8), with the flux directions being indicated by the arrows in FIG. 8. In various exemplary embodiments, the azimuthal span of the radial flux magnets 802 may be larger than that of the tangential flux magnets 801. For example, in an exemplary embodiment for ¾ in. thick magnets (with thickness being measured in a radial direction), the azimuthal span of the radial flux magnets 802 may range from about 54% to about 60%, for example, about 56%, of the pole pitch; and the azimuthal span of the tangential flux magnets 801 may range from about 40% to about 46%, for example, about 44%, of the pole pitch. Those having ordinary skill in the art would understand that the azimuthal span of the magnets may differ based on the overall size of the magnets used.

Determination of the effects of the size of the inner gear ring and the azimuthal spans of the radial and tangential magnets can be modeled by allowing both the inner gear ring radius and the azimuthal span of each of the tangential and radial magnets to vary in a nested loop, mapping these parameters into a multivariable spline, and then using a trust region optimization to find the optimization on both parameters simultaneously. Reference is made to Kano et al., “Optimal curve fitting and smoothing using normalized uniform B-splines: a tool for studying complex systems,” Applied Mathematics and Computation, Elsevier, 2005 and Gill et al., “Practical Optimization,” London, Academic Press, 1981 for exemplary techniques to model the effects of these parameters.

### Controlled Revolution and Prevention of Free Rotation of Input Gear Ring

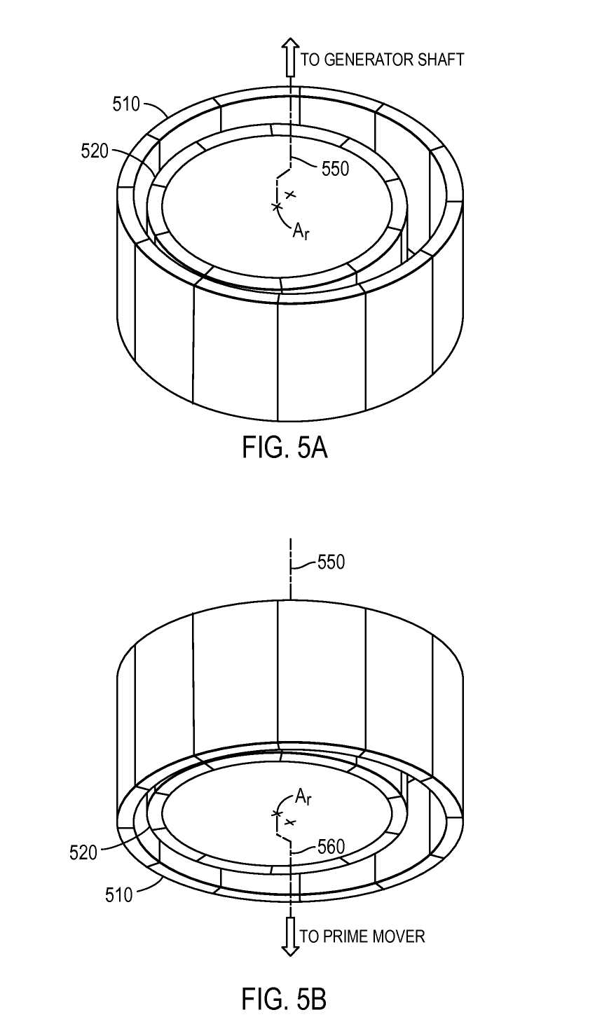

As discussed above, in accordance with various exemplary embodiments, the inner gear ring of a magnetic cycloid gear arrangement can be prevented from freely rotating about its own axis (e.g., Aᵣ in the figures) while it is driven to revolve relative to the outer gear ring such that its axis traces a small orbital trajectory (e.g., T in FIGS. 2B and 4A). For example, the trajectory may be a 1-inch diameter circle when the inner gear ring axis is displaced ½ inch from the outer gear ring axis. Various mechanisms may be used in a magnetic cycloid gear arrangement to realize such a motion of the inner gear ring. For example, as depicted in the schematic perspective views of FIGS. 5A and 5B, an eccentric drive shaft 550 in combination with a universal joint 560 may be utilized to drive the inner gear ring 520 in an eccentric motion and also to constrain the inner gear ring 520 from rotating about its axis Aᵣ; alternatively, a flexible drive shaft (not shown) can be used.

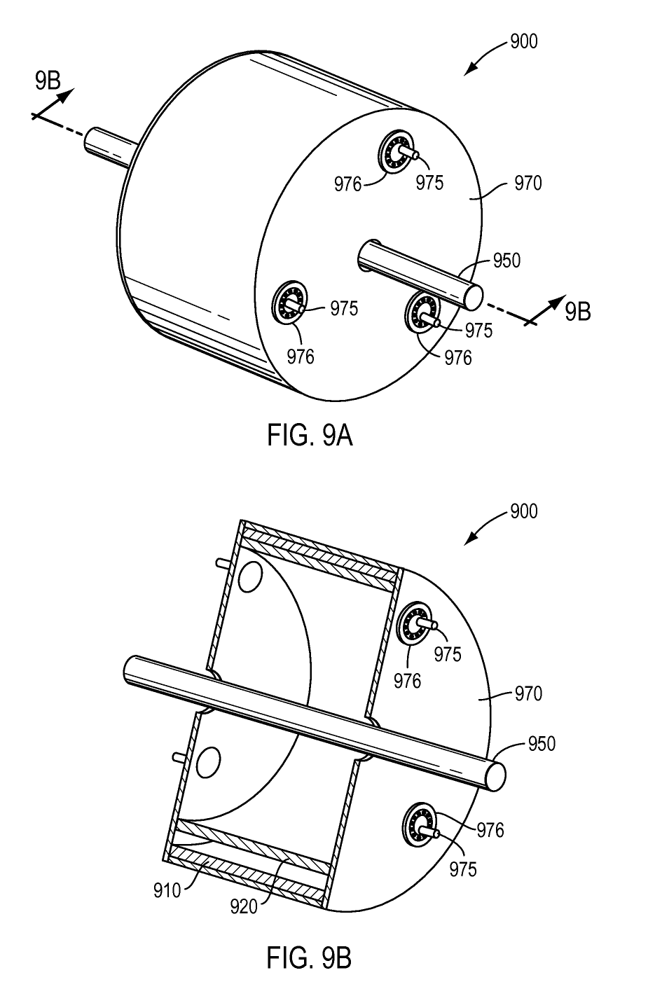

In yet another exemplary embodiment, an eccentric orbital bearing assembly can be used to control the motion of a gear ring. FIGS. 9A and 9B depict views of one exemplary magnetic cycloid gear arrangement 900 that utilizes such an orbital bearing assembly. More specifically, FIG. 9A is a perspective view of the magnetic cycloid gear arrangement and FIG. 9B is a cross-sectional view along line 9B-9B in FIG. 9A. As shown, an orbital bearing assembly can include orbital bearing end plates 970 coupled to the inner gear ring 920. The orbital bearing end plates 970 have openings 976 that cooperate with orbital bearings 975. At the opposite ends of the portions that connect to the orbital end plates 970, orbital bearings 975 may have a leg portion that is fixed to a suitable, stationary support structure (not shown), such as, for example to a fixed structure such as an oil rig frame in use of the magnetic gear in rotary drive equipment for oil rigs. The inner gear ring 920 can be coupled to an input drive shaft 950, which may for example be an eccentric drive shaft as described above with reference to FIGS. 2-5 or otherwise be coupled so as to drive the inner gear ring such that its axis traces the small circle about the axis of the outer gear ring. The input shaft 950 may be connected to a generator or motor such that it rotates at a high speed and low torque. By virtue of the orbital bearing assembly, the movement of the inner gear ring 920 will be constrained from free rotation about its axis and instead will move as a whole in a relatively small circular motion as permitted by the orbital bearing assembly. Those having ordinary skill in the art would appreciate that the orbital bearing assembly shown in FIGS. 9A and 9B is a nonlimiting and exemplary mechanism for constraining the motion of the inner gear ring 920 and that other mechanisms may be suitable for achieving the desired motion. For example, cam rollers may be used in place of the bearing mechanisms 975; however cam rollers may not provide as rigid a restraint on the motion as the orbital bearing mechanisms in some cases.

### Drive Mechanisms for Inner Gear Ring

As described above, an eccentric input drive crank shaft drive driven by an external motor or generator may be used to drive the inner gear ring of a magnetic cycloid gear arrangement in the desired motion. However, because the gear ratios that can be achieved by such magnetic cycloid gear arrangements are so high, e.g., on the order of about 30:1 or more, the torque required to drive the gear need only deliver about 1/30^{th} or less of the desired output torque. Depending on the output torque requirements for an application of the magnetic cycloid gear arrangements, therefore, it may be possible to use relatively small motors, for example, that can be integrated relatively easily as part of the overall gear assembly. For example, various exemplary embodiments contemplate using a magnetic cycloid gear arrangement to drive rotary equipment associated with oil drilling rigs, such as, for example, drawworks, mud pumps, and/or top drives, as described with reference to FIG. 16 and disclosed for example in International Application Nos. PCT/US2013/028538, filed Mar. 1, 2013, entitled “MAGNETIC GEARS, AND RELATED SYSTEMS AND METHODS,” which is incorporated by reference herein. The ability to provide a relatively small, onboard motor to drive the inner gear ring can be particularly useful in such applications where providing relatively compact parts in light of constraints on space may be desirable.

FIG. 10 is a schematic sectional view of an exemplary embodiment of a magnetic cycloid gear arrangement in accordance with an exemplary embodiment and shown for use in driving a top drive mechanism of an oil drilling rig, wherein 1050 represents the pipe (such as pipe 2904 in FIG. 16) of the top drive that carries mud in the direction of the arrow. FIG. 10 shows one representation of how a magnetic cycloid gear arrangement can be used with a top drive of an oil drilling rig, and in particular by relying on a relatively small onboard motor system to drive the inner gear ring.

As show in FIG. 10, small drive motors 1040, which can be, for example, permanent magnet motors or induction motors can be operatively coupled and disposed to directly drive inner gear ring 1020, which in the exemplary embodiment of FIG. 10 is coupled to the pipe 1050 via a structural support 1035 that in an exemplary embodiment can be made of steel, for example. The structural support 1035 can have a substantially circular cross-section, with an outer annular support section 1036 around the inner surface of the inner gear ring 1020 and an inner annular section 1037 that attaches to the pipe 1050. The sections 1036 and 1037 are an integral construction that rotate together as a unitary piece, for example, they can be a single piece structure. The axis Ao for the outer gear ring 1010 is displaced a small distance below the centerline of the pipe 1050 and support structure 1035, with the outer ring being symmetrical, and thus balanced, around its axis Ao.

To provide the eccentric rotation, as described above when using an eccentric crank shaft for example, the motors 1040 can be operatively coupled to drive a eccentric rings 1045, a detailed perspective view of which is shown in FIG. 11. The motors 1040 thus drive the eccentric rings 1045 around the primary rotation axis A denoted in FIG. 10, which in turn imparts the desired small-circular revolving motion (in conjunction with the use of, for example, orbital bearings shown at 1075 in FIG. 10) of the inner gear ring 1020 as described herein. The forces on the outer gear ring which undergo an eccentric motion can be significant, such as for example about 29 k-lbs. Accordingly, the eccentric rings 1045, as shown in the exemplary embodiments of FIGS. 10 and 11, can be provided around their periphery with a bearing 1048. Since in a top drive mechanism, the orientation will be vertical (i.e., rotated 90 degrees counterclockwise from the orientation shown in FIG. 10), the bearing 1048 in an exemplary embodiment may be a tapered bearing or spherical bearing.

An exemplary requirement of the motors is now described with reference to the requirements of one exemplary top drive of an oil drilling rig, wherein the rotation speed of the top drive at maximum torque is 100 rpm and the maximum speed is 200 rpm. The motors drive the eccentric ring and inner gear ring assembly in a revolution about the pipe axis at a rotation rate equal to the gear ratio times the desired output rotation speed. If 31:1 is chosen as the gear ratio and the rotation speed is 100 rpm, the motor drive must operate at a drive speed, Ω of

Ω=31·120=3100 rpm. (1)

At the maximum speed of 200 rpm; the drive speed Ω would be

Ω=31·200=6200 rpm. (2)

At this higher speed of 200 rpm, a four pole induction motor would have to be excited at a frequency ƒ of

$${f}_{4 pole max speed} = \frac{6200}{1750} \cdot 60 = 212 Hz . \qquad ( 3 )$$

At 100 rpm, the excitation frequency would be 106 Hz. At 100 rpm, a two pole induction motor would use an excitation frequency ƒ of

$${f}_{2 pole normal speed} = \frac{31 \cdot 100}{3500} \cdot 60 = 53 Hz . \qquad ( 4 )$$

Regardless of the type of motor, the torque demand T under the exemplary top drive under a maximum continuous load of about 20 kft-lbs would be

$${T}_{motor drive TDS 150} = \frac{20000}{31} = 645 ft \text{-} lbs . \qquad ( 5 )$$

The power requirements P for the motor drive under maximum continuous torque and speed (100 rpm) would be (where ω is angular radian velocity)

$$P = T \cdot ω = \frac{2 e 04 \cdot \frac{4.448}{39.37} \cdot 12}{ } \cdot \frac{100 \cdot 2 \cdot π}{60} = 284 kW = 380.6 hp . \qquad ( 6 )$$

Similar computations can be done for other exemplary top drive or rotary equipment specifications/requirements, as would be understood by those having ordinary skill in the art. By way of example only, various exemplary embodiments of the present disclosure contemplate using the magnetic cycloid gear arrangements with an onboard motor drive system to drive top drives that output a maximum continuous torque ranging from about 20,000 ft-lbs to about 35,000 ft-lbs at a speed ranging from about 100 rpms to 145 rpms, with a maximum speed ranging from about 200 rpms to about 225 rpms and a torque density ranging from about 1.5 ft-lb/in³ to about 2.6 ft-lb/in³. It is contemplated that relatively compact arrangements can be used to deliver these specifications, for example, ranging from about 24 in. to about 28 in. in outer diameter and about 17 in. to about 37 in. in height, in order for example, to accommodate a mud pipe that has an outer diameter ranging from about 2.25 in. to about 3 in. Regardless of the motor selection, in use with a top drive, the mud flow can be considered as a mechanism for cooling the stator. In an exemplary embodiment, if induction motors are used, it may be desirable to provide a blower for cooling the rotor.

### Motor Synchronization

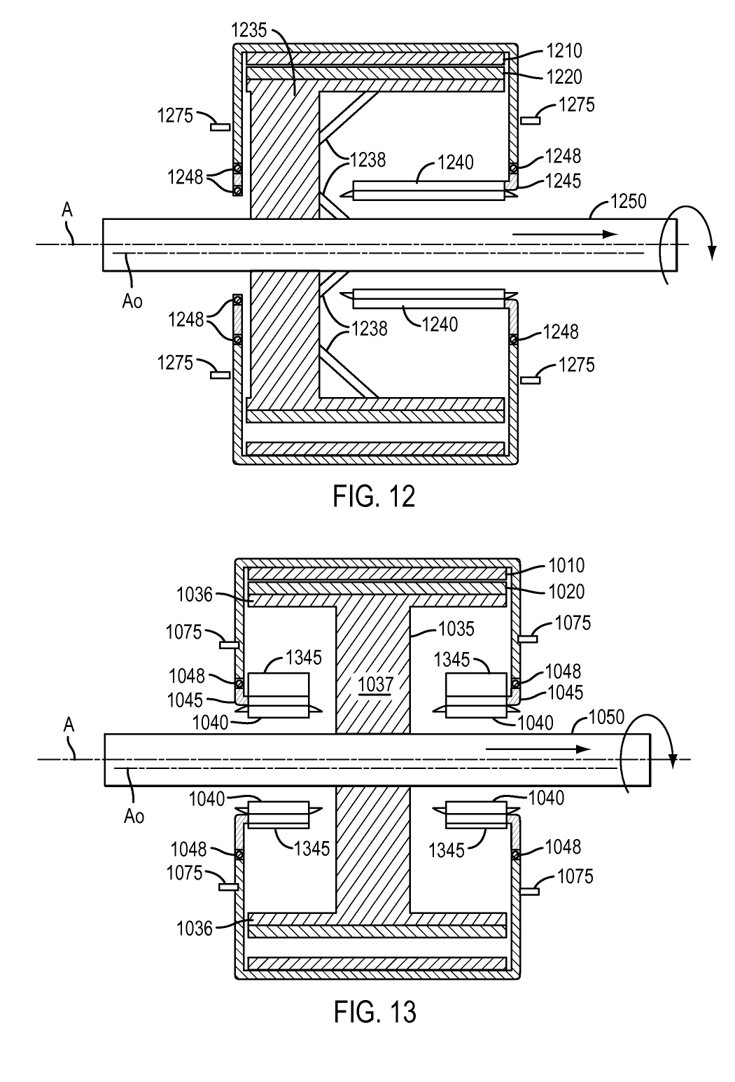

With the drive motors in the exemplary embodiment of FIG. 10 being separated due to their positioning at opposite ends of the gear arrangement, control of eccentric motion of the inner gear ring can pose challenges if the motors (e.g., at each end 1001, 1002 in FIG. 10) do not operate synchronously with each other. FIG. 12 shows an exemplary embodiment in which the volume for the motor drive is provided on one side of the gear arrangement (i.e., to the right side in FIG. 12). The synchronization issues in such a configuration are alleviated; however, the support structure 1235 for the inner gear ring 1220 relative to the pipe 1250, which can be half of the structure 1035 in FIG. 10 with a system of gussets 1238 for additional support in an exemplary configuration, may provide difficulties relating to balancing of the gear arrangement. It is noted that the other components of FIG. 12 are labeled using reference numerals similar to that of FIG. 10, except corresponding to 1200 series.

Various solid state control mechanisms may be implemented to maintain a synchronous operation of the motors when using the configuration of the motors shown in FIG. 10. For example, the use of a phase lock loop or other similar solid state control mechanism may be used. As an alternative exemplary embodiment, permanent magnet motors with stators connected in series may be used to achieve synchronous operation.

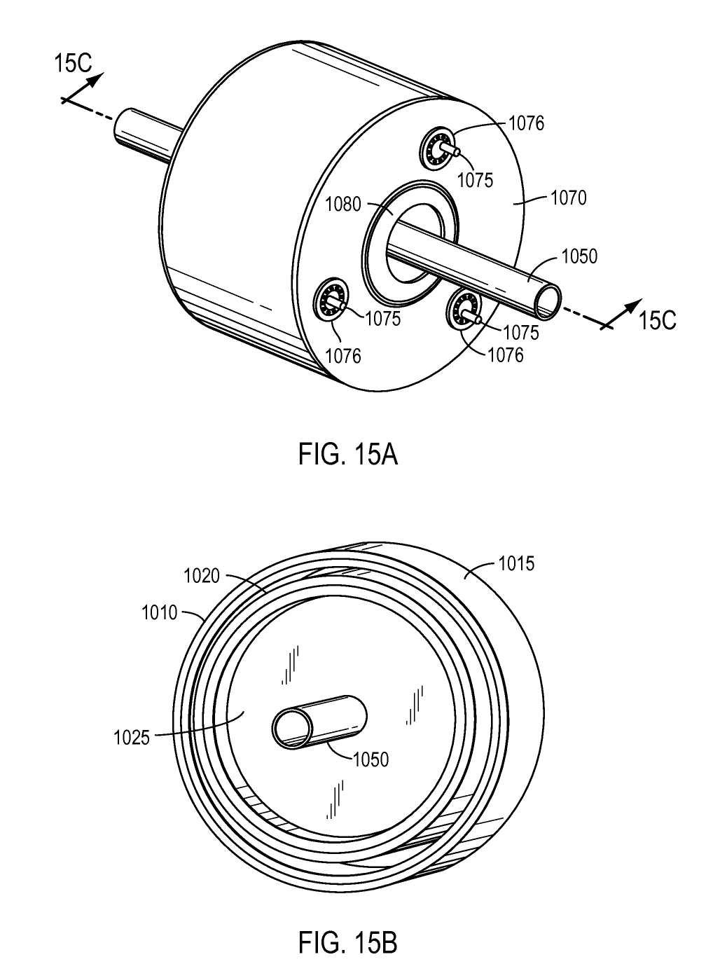

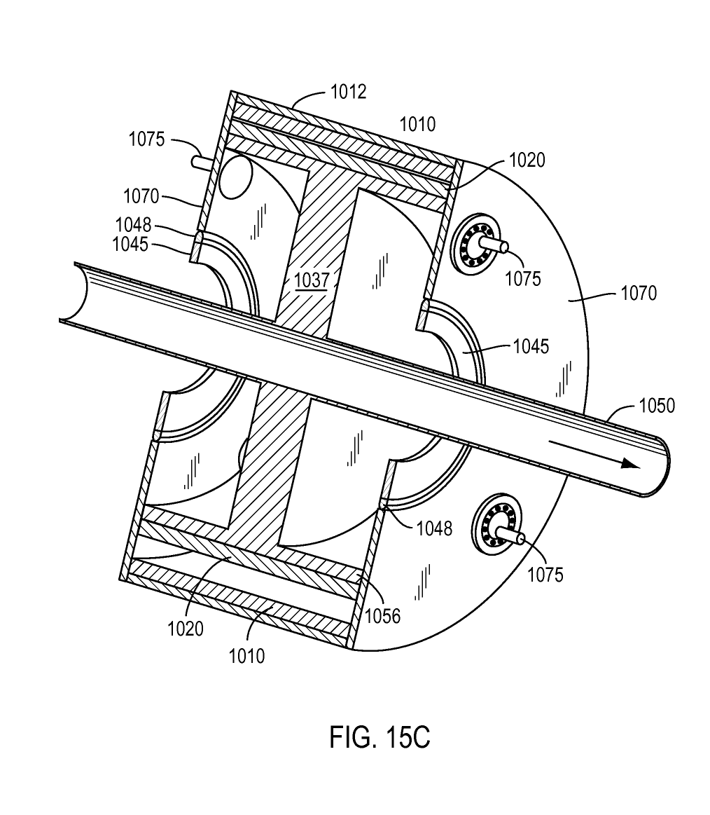

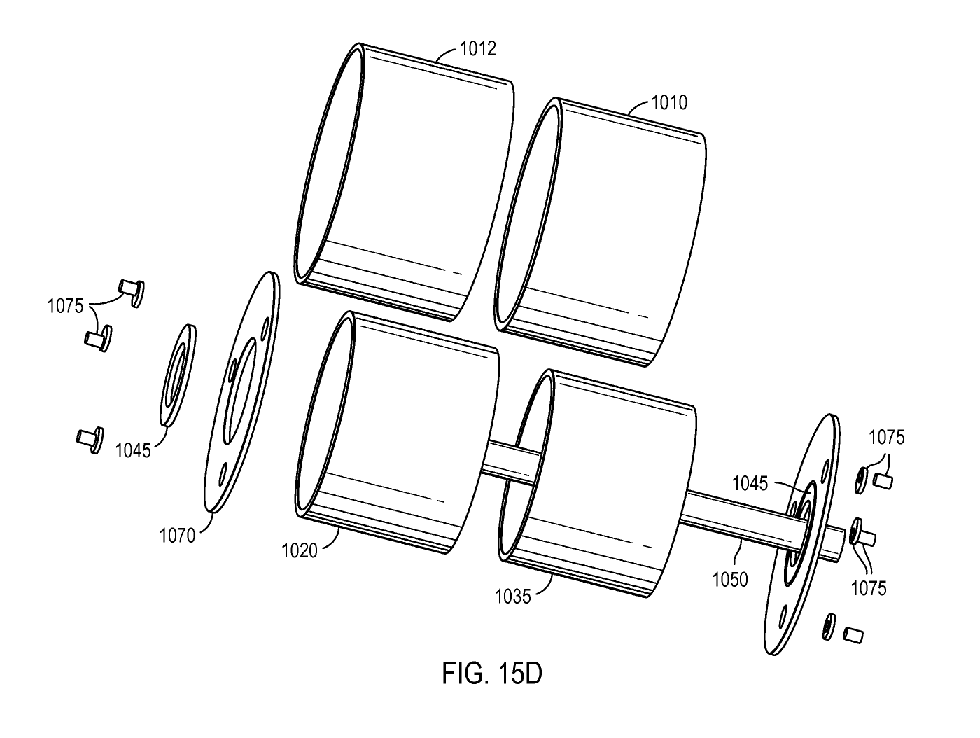

For clarifying illustrative purposes, reference is made to FIGS. 15A-15D which depict perspective views of portions of the magnetic gear arrangement for driving a top drive as shown in the cross-sectional schematic view of FIG. 10; the motor drive mechanism not being depicted. Parts that correspond to those described with reference to FIG. 10 are labeled with the same reference numerals in FIGS. 15A-15D.

### Balancing Considerations

Balance of the magnetic cycloid gear arrangements in various exemplary embodiments also can pose a design consideration in order to provide a smooth take off of the torque transmission and to reduce any noise and potential wear on the various components. With reference again to use the magnetic gear arrangement used to drive the top drive in the exemplary embodiment of FIG. 10, it can be seen that the eccentric rings 1045 and the rotors of the motors 1040 rotate about the primary axis A at high speed, as described above. Because of the orbital bearings 1075 (or other mechanisms used to constrain the motion of the inner gear ring 1020), all components (e.g., including the inner and outer gear rings 1020, 1010) above the tapered bearings 1048 of the eccentric rings 1045 exhibit a constrained movement of revolving in a small circle whose radius is equal to the displacement of the outer ring axis Ao from the primary rotation axis A.

One source of potential imbalance, therefore, is caused by the material offset of the components with respect to the primary rotation axis A. To compensate for this material, and thus mass, difference, various exemplary embodiments contemplate using a counterweight. FIG. 13 depicts one exemplary embodiment that includes using counterweights 1345 attached to the rotor of the motors 1040, with the remaining components in FIG. 13 being the same as the exemplary embodiment of FIG. 10. The configuration of the counterweights can be such that the center of mass of the overall gear arrangement is brought back to the primary rotation axis A. In various exemplary embodiments, the counterweights 1345 can be in the form of eccentric ring structures similar to the rings 1045 but with the mass distribution on the opposite side of those rings.

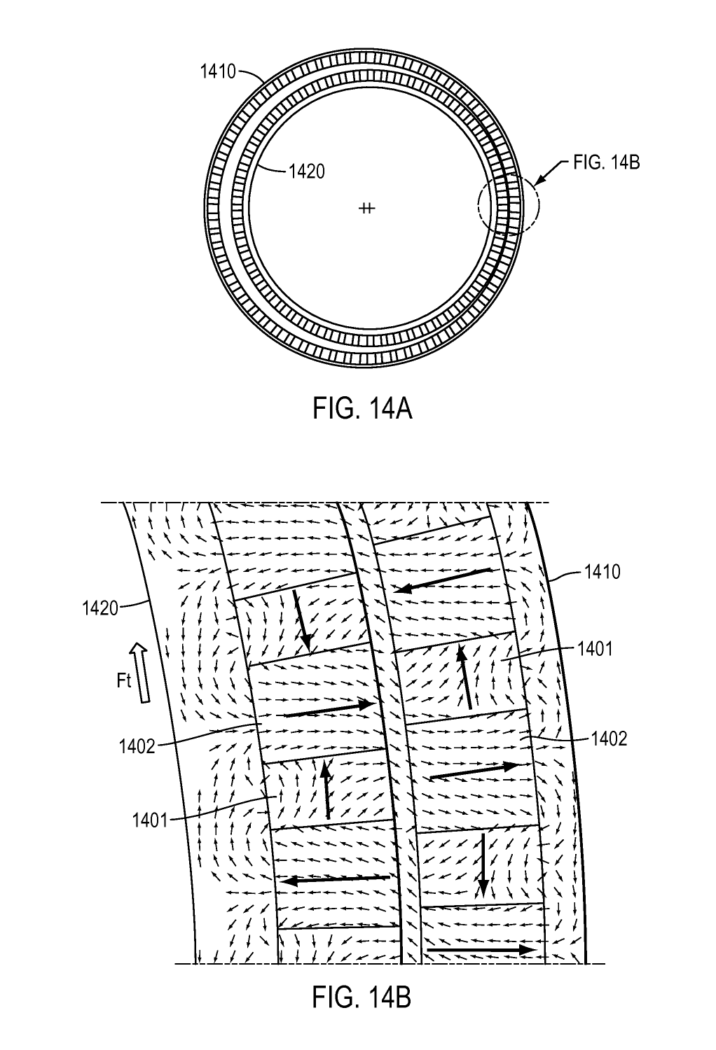

Another source for the potential imbalance problem is caused by the magnetic forces. The magnetic forces that generate the desired torque output and gear ratio also may result in an uncompensated side load on the magnetic cycloid gear arrangements in accordance with various exemplary embodiments. In conventional permanent magnetic motors, the magnetic forces generally flip direction 180°, or at least balance every 360°. However, as described above, in various exemplary embodiments of the magnetic cycloid gear arrangement described herein, there are large tangential magnetic forces generated by the magnets of the inner and outer gear ring, for example at the 3:00 position with reference to the description of FIGS. 7A-7C above and as further illustrated in FIGS. 14A and 14B, which show the outer and inner gear rings 1410, 1420 with the small arrows representing the magnetic fluxes and the large arrows representing the overall flux direction (i.e., tangential flux magnets 1401 and radial flux magnets 1402). The arrow Fₜ represents the large tangential force that is generated, which results from the fluxes depicted in the air gaps on either side of the gear rings 1410, 1420 and between the gear rings 1410, 1420. This tangential force changes direction with the degree of the torque demand, for example, changing from primarily radial at low torque to primarily tangential at high torque.

Although only a few exemplary embodiments have been described in detail above, those skilled in the art will readily appreciate that many modifications are possible in the example embodiments without materially departing from this disclosure. Accordingly, all such modifications are intended to be included within the scope of this disclosure as defined in the following claims. By way of example, those having ordinary skill in the art will appreciate that the magnetic cycloid gear arrangements in accordance with various exemplary embodiments can be used in a variety of applications other than to drive rotary equipment associated with oil drilling rigs, with appropriate modifications being determined from routine experimentation based on principles set for the herein.

It is to be understood that the various embodiments shown and described herein are to be taken as exemplary. Elements and materials, and arrangements of those elements and materials, may be substituted for those illustrated and described herein, and portions may be reversed, all as would be apparent to one skilled in the art after having the benefit of the description herein. Changes may be made in the elements described herein without departing from the spirit and scope of the present disclosure and following claims, including their equivalents.

Those having ordinary skill in the art will recognize that various modifications may be made to the configuration and methodology of the exemplary embodiments disclosed herein without departing from the scope of the present teachings. By way of example only, the cross-sectional shapes and relative sizes of the gear rings may be modified and a variety of cross-sectional configurations may be utilized, including, for example, circular or oval cross-sectional shapes. Moreover, those having ordinary skill in the art would understand that the various dimensions, number of magnets and pole pairs, etc. discussed with respect to exemplary embodiments are nonlimiting and other sizes and configurations are contemplated as within the scope of the present disclosure and can be selected as desired for a particular application.

Those having ordinary skill in the art also will appreciate that various features disclosed with respect to one exemplary embodiment herein may be used in combination with other exemplary embodiments with appropriate modifications, even if such combinations are not explicitly disclosed herein.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the magnetic gears and methods of the present disclosure without departing from the scope the present disclosure and appended claims. Other embodiments of the disclosure will be apparent to those skilled in the art from consideration of the specification and practice of the disclosure disclosed herein. It is intended that the specification and examples be considered as exemplary only.

What is claimed is:

1. A magnetic cycloid gear comprising:
an outer gear member comprising a first plurality of magnets that provide a first number of magnetic pole pairs, wherein the outer gear member has an outer gear member axis;
an inner gear member comprising a second plurality of magnets that provide a second number of magnetic pole pairs, wherein the inner gear member has an inner gear member axis that is offset from the outer gear member axis and wherein the second number of magnetic pole pairs differs from the first number of magnetic pole pairs;
a drive mechanism operatively coupled to the inner gear member to impart a rotary motion to the inner gear member to revolve the inner gear member in an eccentric manner relative to the outer gear member axis; and
a constraint mechanism coupled to the inner gear member to prevent the inner gear member from rotating about an axis of the inner gear member as it revolves;
wherein the outer gear member is movable in a rotary manner in response to the inner gear member revolving.

2. The magnetic cycloid gear of claim 1, wherein the drive mechanism is associated with a high speed, low torque input and the outer gear member rotary motion is a low speed, high torque output.

3. The magnetic cycloid gear of claim 1, wherein the drive mechanism comprises a motor positioned onboard the gear.

4. The magnetic cycloid gear of claim 3, wherein the drive mechanism further comprises an eccentric ring coupled between the motor and the inner gear member.

5. The magnetic cycloid gear of claim 1, wherein the constraint mechanism comprises an orbital bearing assembly.

6. The magnetic cycloid gear of claim 1, wherein the gear ratio is at least 30:1.

7. The magnetic cycloid gear of claim 1, wherein the gear outputs a torque ranging from about 25,000 ft-lbs to about 29,000 ft-lbs.

8. The magnetic cycloid gear of claim 1, further comprising a counterweight device positioned to adjust a center of mass of the gear to be about a rotation axis of the gear.

9. The magnetic cycloid gear of claim 1, wherein a radial differential between an outer surface of the inner gear member and an inner surface of the outer gear member in a concentric arrangement of the gear members ranges from about 0.1 in. to about 0.6 in.

10. The magnetic cycloid gear of claim 9, wherein the axis of the inner gear member and the axis of the outer gear member are offset from each other by an amount ranging from about 0.1 in. to about 0.6 in.

11. A system comprising:
the magnetic cycloid gear of claim 1;
a high speed, low torque input shaft operatively coupled to the inner gear member of the magnetic gear;
a low speed, high torque output shaft operatively coupled to the outer gear member of the magnetic gear; and
rotary equipment associated with an oil drilling rig operatively coupled to be driven by the output shaft.

12. The system of claim 11, wherein the rotary equipment is chosen from a top drive, drawworks, and a mud pump.

13. A method of torque conversion comprising:
imparting a rotary drive motion to an inner gear member comprising a first plurality of magnets providing a first number of pole pairs, wherein the rotary drive motion is from a high speed, low torque input;
constraining the rotary motion of the inner gear member from rotating about an axis of the first gear member, as the inner gear member is driven to revolve in an eccentric manner within an outer gear member, wherein the outer gear member comprises a second plurality of magnets providing a second number of pole pairs that differs from the first number of pole pairs; and
in response to the movement of the inner gear member, permitting the outer gear member to move in a rotary manner to provide a low speed, high torque output.

14. The method of claim 13, further comprising converting the high speed, low torque input to the low speed, high torque output at a gear ratio of at least about 30:1.

15. The method of claim 13, wherein in response to the movement of the inner gear member, the outer gear member rotates about an axis of the outer gear member.
